(19) United States
(12) Patent Application Publication
(10) Pub. No.: US 2010/0120307 A1
(43) Pub. Date: May 13, 2010

(54) Bio-degradable PVC Laminated Fabric for Banner

(76) Inventor: Joe U. Noh, Fullerton, CA (US)

Correspondence Address: PARK LAW FIRM, 3255 WILSHIRE BLVD, SUITE 1110, LOS ANGELES, CA, 90010, US

(21) Appl. No.: 12/269,773

(22) Filed: Nov. 12, 2008

(51) Int. Cl. D03D 9/00; C08F 214/06

(52) U.S. Cl. 442/1; 524/567; 524/569

(57) ABSTRACT

A bio-degradable PVC laminated fabric is provided. The biodegradable PVC laminated fabric comprises one or more bio-degradable laminating layers and one or more bio-degradable or regular scrims. The one or more bio-degradable laminating layers comprise plastic resin and bio-degradable additive. The one or more bio-degradable scrims comprise plastic resin and bio-degradable additive. Each of the one or more scrims is laminated on at least one of the bio-degradable laminating layer. Each bio-degradable laminating layer comprises bio-degradable additive by a first weight ratio.

### BACKGROUND OF THE INVENTION

The present invention relates to a bio-degradable PVC laminated fabric. More particularly, this invention relates to a bio-degradable PVC laminated fabric, which includes bio-degradable additive.

Plastic is used widely and conveniently. It is almost impossible to imagine a world without plastic.

However, plastics are durable and degrade very slowly. Plastic trashes can be found everywhere including the arctic area.

Burning is not a solution to the problem because usually they tend to release toxic fumes. They must be treated not to affect against the environment.

Plastics are used heavily in many commodities including banner for example.

Accordingly, a need for a bio-degradable PVC laminated fabric has been present for a long time considering the expansive usage and potential hazard of plastic material. This invention is directed to solve these problems and satisfy the long-felt need.

### SUMMARY OF THE INVENTION

The present invention contrives to solve the disadvantages of the prior art.

An objective of the invention is to provide a bio-degradable PVC laminated fabric.

Another object of the invention is to provide a bio-degradable PVC laminated fabric, which is degradable not being hazardous to the environment.

Still another object of the invention is to provide a bio-degradable PVC laminated fabric, which is manufactured by adding bio-degradable additives.

An aspect of the present invention provides a bio-degradable PVC laminated fabric.

The bio-degradable PVC laminated fabric comprises one or more bio-degradable laminating layers and one or more bio-degradable scrims.

The one or more bio-degradable laminating layers comprises plastic resin and bio-degradable additive. The one or more bio-degradable scrims comprises plastic resin and bio-degradable additive.

Each of the one or more bio-degradable scrims is laminated on at least one of the bio-degradable laminating layer.

Each bio-degradable laminating layer comprises bio-degradable additive by a first weight ratio. Each bio-degradable scrim comprises bio-degradable additive by a second weight ratio. The first weight ratio is different than the second weight ration.

Each of the bio-degradable laminating layer may be fused to neighboring bio-degradable scrim.

Alternatively, each of the biodegradable laminating layer may be glued to neighboring bio-degradable scrim.

The first weight ratio of bio-degradable additive to plastic resin may be from about 0.5 percent to about 2.0 percent by weight. The first weight ratio may be lower than the second weight ration. Alternatively, the first weight ratio may be higher than the second weight ration.

The second weight ratio of bio-degradable additive to plastic resin may be from about 0.5 percent to about 2.0 percent by weight.

The first weight ratio may be lower than the second weight ratio. Alternatively, the first weight ratio may be higher than the second weight ratio.

The bio-degradable additive may be distributed in plastic resin substantially evenly.

Another aspect of the present invention provides a method for manufacturing biodegradable PVC laminated fabric.

The method comprises steps of: providing plastic resin and other raw material of a first amount; mixing bio-degradable additive by a first weight ratio to the provided plastic resin and other raw material; and adding colorant and further mixing for a first time period.

The first weight ratio is from about 0.5 percent to about 2.0 percent by weight, and bio-degradable additive is distributed in plastic resin substantially evenly.

The other raw material may comprise polyvinyl chloride (PVC), PVC plasticizer, liquid stabilizing powder, liquid stabilizing phosphate ester, CaCO3, TiO2, and color gauze. The PVC plasticizer may comprise dioctyl phthalate (DOP).

The step of mixing may comprise a step of keeping temperature of the mixed batch over about 190 degrees in Fahrenheit and under about 400 degrees in Fahrenheit.

The method may further comprise a step of knitting or weaving bio-degradable scrim having a predetermined eye size and a predetermined string diameter.

The method may further comprise a step of milling bio-degradable laminating layer. The method may further comprise a step of laminating the biodegradable scrim onto the biodegradable laminating layer.

The step of laminating may comprise steps of: fusing thermally the bio-degradable scrim onto the bio-degradable laminating layer; and gluing biodegradable scrim onto the bio-degradable laminating layer.

The biodegradable PVC laminating fabric comprises: polyvinyl chloride (PVC) of about 100.0 in weight; PVC plasticizer of about 31.6 in weight; ESO (epoxidized soybean oil) of about 4.4 in weight; liquid stabilizer of about 1.0 in weight; powder stabilizer of about 3.5 in weight; phosphate ester of about 0.3 in weight; CaCO3 of about 30.0 in weight; TiO2 of about 10.6 in weight; color gauze of about 0.0035 in weight; and biodegradable additive of about 3.0 in weight.

The advantages of the present invention are: (1) the bio-degradable PVC laminated fabric is degradable in the environment; and (2) the bio-degradable PVC laminated fabric is easily manufactured by adding biodegradable additives.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a cross-sectional view showing a bio-degradable PVC laminated fabric according to an embodiment of the present invention;

FIG. 2 is a perspective exploded view of the bio-degradable PVC laminated fabric of FIG. 1;

FIG. 3 is a cross-sectional view showing a bio-degradable PVC laminated fabric according to another embodiment of the present invention;

FIG. 4 is a perspective exploded view of the bio-degradable PVC laminated fabric of FIG. 3;

FIG. 5 is a cross-sectional view showing a bio-degradable PVC laminated fabric according to still another embodiment of the present invention;

FIG. 6 is a perspective exploded view of the bio-degradable PVC laminated fabric of FIG. 5;

FIG. 7 is a flowchart of a method for manufacturing a bio-degradable PVC laminated fabric according to an embodiment of the present invention; and

FIG. 8 is a flowchart of a method for manufacturing a biodegradable PVC laminated fabric according to another embodiment of the present invention.

### DETAILED DESCRIPTION EMBODIMENTS OF THE INVENTION

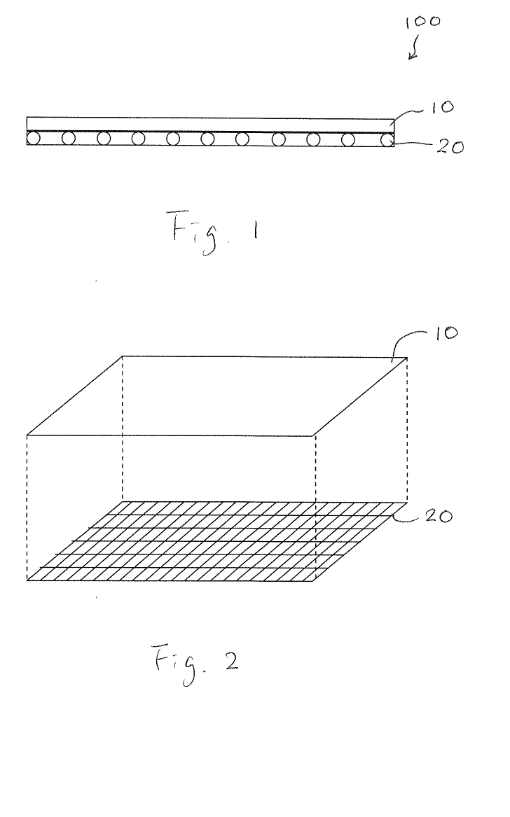

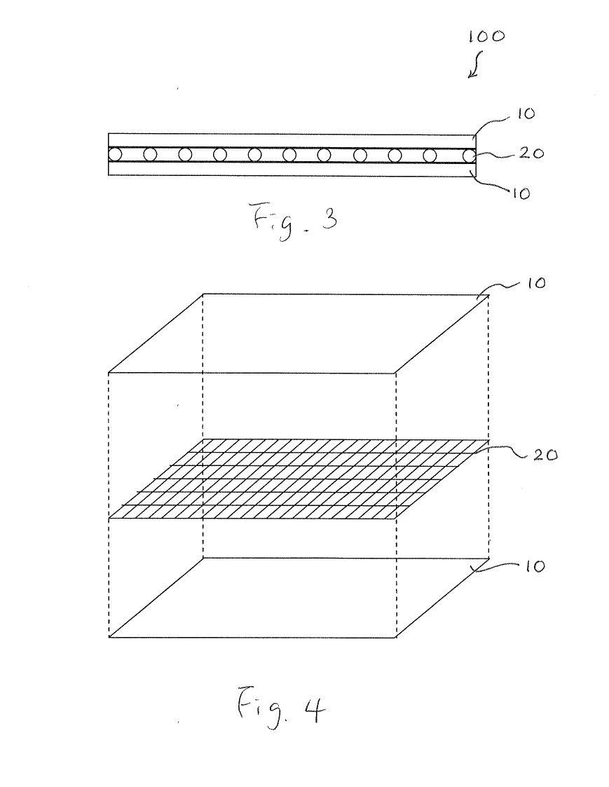

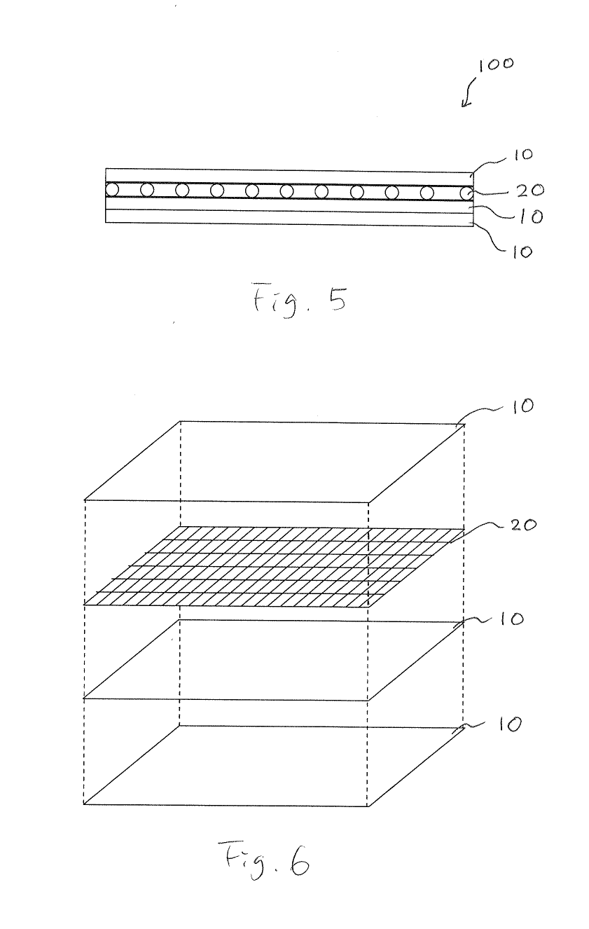

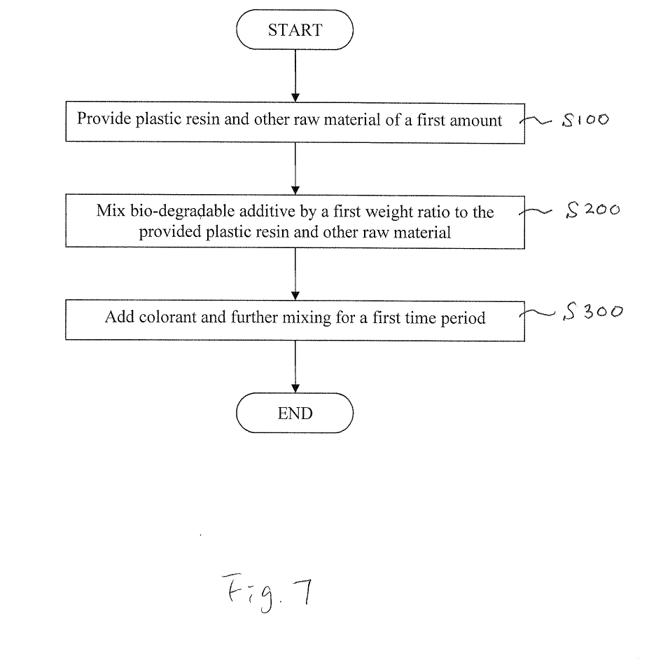

FIGS. 1-6 show bio-degradable PVC laminated fabrics 100 according to embodiments of the present invention.

The bio-degradable PVC laminated fabric 100 comprises one or more bio-degradable laminating layers 10 and one or more bio-degradable scrims 20.

The one or more bio-degradable laminating layers 10 comprise plastic resin and bio-degradable additive. The one or more bio-degradable scrims 20 comprise plastic resin and bio-degradable additive.

Each of the one or more bio-degradable scrims 100 is laminated on at least one of the bio-degradable laminating layer 10.

Each bio-degradable laminating layer 10 comprises bio-degradable additive by a first weight ratio. Each bio-degradable scrim 20 comprises bio-degradable additive by a second weight ratio. The first weight ratio is different than the second weight ration.

Each of the bio-degradable laminating layer 10 may be fused to neighboring bio-degradable scrim 20.

Alternatively, each of the bio-degradable laminating layer 10 may be glued to neighboring bio-degradable scrim 20.

The first weight ratio of bio-degradable additive to plastic resin may be from about 0.5 percent to about 2.0 percent by weight. The first weight ratio may be lower than the second weight ration. Alternatively, the first weight ratio may be higher than the second weight ration.

The second weight ratio of bio-degradable additive to plastic resin may be from about 0.5 percent to about 2.0 percent by weight.

The first weight ratio may be lower than the second weight ratio. Alternatively, the first weight ratio may be higher than the second weight ratio.

The biodegradable additive may be distributed in plastic resin substantially evenly.

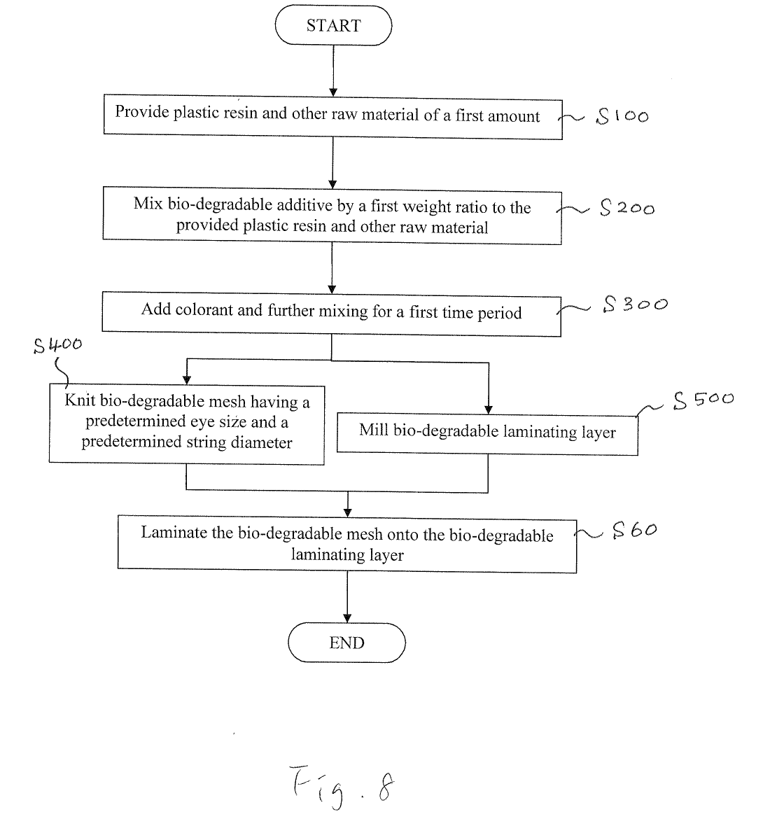

Another aspect of the present invention provides a method for manufacturing bio-degradable PVC laminated fabric 100 as shown in FIGS. 7 and 8.

The method comprises steps of: providing plastic resin and other raw material of a first amount (S100); mixing bio-degradable additive by a first weight ratio to the provided plastic resin and other raw material (S200); and adding colorant and further mixing for a first time period (S300).

The first weight ratio is from about 0.5 percent to about 2.0 percent by weight, and biodegradable additive is distributed in plastic resin substantially evenly.

In certain embodiments of the invention, the bio-degradable additive may be distributed in a crisscross pattern. Then, the portion containing the bio-degradable additive will be gone away leaving the smaller pieces of the fabric.

The other raw material may comprise polyvinyl chloride (PVC), PVC plasticizer, liquid stabilizing powder, liquid stabilizing phosphate ester, CaCO3, TiO2, and color gauze. The PVC plasticizer may comprise dioctyl phthalate (DOP).

The step of mixing (S200) may comprise a step of keeping temperature of the mixed batch over about 190 degrees in Fahrenheit and under about 400 degrees in Fahrenheit.

The method may further comprise a step of knitting or weaving bio-degradable scrim having a predetermined eye size and a predetermined string diameter (S400), in which a bio-degradable scrim 20 is obtained. The scrim's dimension may be controlled according to desired mechanical features. For example, if the fabric needs to be tough enough to stand tensile strain, the eye size may be smaller or the string diameter may be larger.

The method may further comprise a step of milling (S500) bio-degradable laminating layer 10, in which a bio-degradable laminating layer 10 is obtained.

The method may further comprise a step of laminating (S600) the bio-degradable scrim 20 onto the bio-degradable laminating layer 10, which are obtained by the previous steps S400 and S500.

Of course, the steps S400 and S500 may be repeated many times to obtain all the necessary layers or scrims.

The step of laminating (S600) may comprise steps of: fusing thermally the bio-degradable scrim 20 onto the bio-degradable laminating layer 10; and gluing bio-degradable scrim 20 onto the bio-degradable laminating layer 10. These steps of fusing or gluing are performed alternatively. In certain embodiments, both of the steps may be used in a single fabric.

Usually, the step of laminating steps (S600) may comprises lining a scrim into a layer, or sandwiching a scrim between two layers.

The bio-degradable PVC laminating fabric comprises: polyvinyl chloride (PVC) of about 100.0 in weight; PVC plasticizer of about 31.6 in weight; ESO (epoxidized soybean oil) of about 4.4 in weight; liquid stabilizer of about 1.0 in weight; powder stabilizer of about 3.5 in weight; phosphate ester of about 0.3 in weight; CaCO3 of about 30.0 in weight; TiO2 of about 10.6 in weight; color gauze of about 0.0035 in weight; and bio-degradable additive of about 3.0 in weight.

Recently, a couple of types of bio-degradable additives are available commercially. Such bio-degradable additives include ECM MasterBatch Pellets ECM6.7001. However, the present invention is not limited to a specific product from a company. Other types of biodegradable additive may be used for a bio-degradable PVC laminating fabric. In certain embodiments of the invention, especially when the other types of bio-degradable additives are used, the weight ration of the additive to the fabric may change according to the types so as to obtain the better results for a specific application.

Especially, the bio-degradable PVC laminating fabric may be used for a banner material. Even though the bio-degradable PVC laminating fabric is used as a banner material in a harsh environment, it is strong enough to stand a gust, for example, since the fabric contains the scrim structure. In such case, the scrim may be made of other degradable fibers.

In certain embodiments of the invention, the scrim 20 may comprise a mesh having a predetermined eye size and string diameter. Each string of the mesh is biodegradable.

In certain embodiments of the invention, the scrim 20 may comprise a mesh having a predetermined eye size and string diameter, which is regular, not biodegradable.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A bio-degradable PVC laminated fabric for banner comprising:
one or more bio-degradable laminating layers, wherein each bio-degradable laminating layer comprises plastic resin and bio-degradable additive; and
one or more bio-degradable scrims, wherein each scrim comprises plastic resin and bio-degradable additive,
wherein each of the one or more bio-degradable scrims is laminated on at least one of the bio-degradable laminating layer,
wherein each bio-degradable laminating layer comprises bio-degradable additive by a first weight ratio,
wherein each bio-degradable scrim comprises bio-degradable additive by a second weight ratio, and
wherein the first weight ratio is different than the second weight ration.

2. The bio-degradable PVC laminated fabric of claim 1, wherein each of the bio-degradable laminating layer is fused to neighboring bio-degradable scrim.

3. The biodegradable PVC laminated fabric of claim 1, wherein each of the bio-degradable laminating layer is glued to neighboring bio-degradable scrim.

4. The bio-degradable PVC laminated fabric of claim 1, wherein the first weight ratio of bio-degradable additive to plastic resin is from about 0.5 percent to about 2.0 percent by weight.

5. The bio-degradable PVC laminated fabric of claim 4, wherein the first weight ratio is lower than the second weight ration.

6. The bio-degradable PVC laminated fabric of claim 4, wherein the first weight ratio is higher than the second weight ration.

7. The bio-degradable PVC laminated fabric of claim 1, wherein the second weight ratio of bio-degradable additive to plastic resin is from about 0.5 percent to about 2.0 percent by weight.

8. The biodegradable PVC laminated fabric of claim 7, wherein the first weight ratio is lower than the second weight ratio.

9. The bio-degradable PVC laminated fabric of claim 7, wherein the first weight ratio is higher than the second weight ratio.

10. The bio-degradable PVC laminated fabric of claim 1, wherein bio-degradable additive is distributed in plastic resin substantially evenly.

11. A method for manufacturing bio-degradable PVC laminated fabric for banner, the method comprising steps of:
providing plastic resin and other raw material of a first amount;
mixing bio-degradable additive by a first weight ratio to the provided plastic resin and other raw material; and
adding colorant and further mixing for a first time period,
wherein the first weight ratio is from about 0.5 percent to about 2.0 percent by weight, and wherein bio-degradable additive is distributed in plastic resin substantially evenly.

12. The method of claim 11, wherein the other raw material comprises polyvinyl chloride (PVC), PVC plasticizer, liquid stabilizing powder, liquid stabilizing phosphate ester, CaCO3, TiO2, and color gauze.

13. The method of claim 12, wherein the PVC plasticizer comprises dioctyl phthalate (DOP).

14. The method of claim 11, wherein the step of mixing comprises a step of keeping temperature of the mixed batch over about 190 degrees in Fahrenheit and under about 400 degrees in Fahrenheit.

15. The method of claim 11, further comprising a step of knitting or weaving biodegradable scrim having a predetermined eye size and a predetermined string diameter.

16. The method of claim 15, further comprising a step of milling biodegradable laminating layer.

17. The method of claim 16, further comprising a step of laminating the bio-degradable scrim onto the bio-degradable laminating layer.

18. The method of claim 11, wherein the step of laminating comprises steps of:
fusing thermally the bio-degradable scrim onto the bio-degradable laminating layer; and
gluing bio-degradable scrim onto the biodegradable laminating layer.

19. The method of claim 11, wherein the biodegradable PVC laminating fabric comprises:
polyvinyl chloride (PVC) of about 100.0 in weight;
PVC plasticizer of about 31.6 in weight;
epoxidized soybean oil (ESO) of about 4.4 in weight;
liquid stabilizer of about 1.0 in weight;
powder stabilizer of about 3.5 in weight;
phosphate ester of about 0.3 in weight;
CaCO3 of about 30.0 in weight;
TiO2 of about 10.6 in weight;
color gauze of about 0.0035 in weight; and
bio-degradable additive of about 3.0 in weight.

20. A bio-degradable PVC laminated fabric for banner comprising:
one or more bio-degradable laminating layers, wherein each bio-degradable laminating layer comprises plastic resin and bio-degradable additive; and
one or more scrims, wherein each scrim comprises plastic resin,
wherein each of the one or more scrims is laminated on at least one of the bio-degradable laminating layer, wherein each bio-degradable laminating layer comprises bio-degradable additive by a first weight ratio, wherein each of the bio-degradable laminating layer is fused to neighboring scrim or glued to neighboring bio-degradable scrim, wherein the first weight ratio of bio-degradable additive to plastic resin is from about 0.5 percent to about 2.0 percent by weight.
